(19) United States
(12) Patent Application Publication
(10) Pub. No.: US 2021/0109245 A1
(43) Pub. Date: Apr. 15, 2021

(54) DOWNHOLE IMAGING SYSTEMS, DOWNHOLE ASSEMBLIES, AND RELATED METHODS

(71) Applicant: Baker Hughes Oilfield Operations LLC, Houston, TX (US)

(72) Inventor: Sebastian Jung, Isernhagen (DE)

(21) Appl. No.: 17/066,306

(22) Filed: Oct. 8, 2020

Related U.S. Application Data
(60) Provisional application No. 62/913,325, filed on Oct. 10, 2019.

(51) Int. Cl. G01V 1/52; G01V 11/00; G01V 1/02

(52) U.S. Cl. CPC G01V 1/52; G01V 2210/121; G01V 1/159; G01V 11/002

(57) ABSTRACT

A downhole imaging system comprises an imaging device operably coupled to a drill string and configured to generate an image of a subterranean formation from within a wellbore. The downhole imaging system comprises a processor operably coupled to the imaging device. The imaging device includes a sensor comprising a transmitter and a receiver, and a coding mask located between the sensor and the subterranean formation. Downhole assemblies including such devices and methods of generating an image of a subterranean formation in a wellbore are also disclosed.

### CROSS-REFERENCE TO RELATED APPLICATION

This application claims the benefit under 35 U.S.C. § 119(e) of U.S. Provisional Patent Application Ser. No. 62/913,325 filed Oct. 10, 2019, the disclosure of which is hereby incorporated herein in its entirety by this reference.

### TECHNICAL FIELD

Embodiments of the disclosure relate generally to drilling systems including an imaging device, to downhole assemblies including such devices, and to related methods. More particularly, embodiments of the disclosure relate to downhole imaging systems and downhole assemblies including a sensor (e.g., an acoustic emission transducer) and an aperture mask (e.g., a coding mask) and to related methods, for producing high-resolution images of a wellbore to determine one or more properties of a subterranean formation.

### BACKGROUND

Wellbores are formed in subterranean formations for various purposes including, for example, extraction of oil and gas and extraction of geothermal heat from the subterranean formation. Wellbores may be formed in a subterranean formation using a drill bit such as, for example, an earth-boring rotary drill bit. Different types of earth-boring rotary drill bits are known in the art including, for example, fixed-cutter bits (which are often referred to in the art as “drag” bits), rolling-cutter bits (which are often referred to in the art as “rock” bits), diamond-impregnated bits, and hybrid bits (which may include, for example, both fixed cutters and rolling cutters). The drill bit is rotated and advanced into the subterranean formation. As the drill bit rotates, the cutters or abrasive structures thereof cut, crush, shear, and/or abrade away the formation material to form the wellbore. A diameter of the wellbore drilled by the drill bit may be defined by the cutting structures disposed at the largest outer diameter of the drill bit.

The drill bit is coupled, either directly or indirectly, for example through a downhole motor, steering assembly and other components, to an end of what is referred to in the art as a “drill string,” which comprises a series of elongated tubular segments connected end-to-end that extends into the wellbore from the surface of the formation. Often various tools and components, including downhole sensors, imaging devices, and the drill bit, may be coupled together at the distal end of the drill string at the bottom of the wellbore being drilled. This assembly of tools and components is referred to in the art as a “bottom-hole assembly” (BHA).

The drill bit may be rotated within the wellbore by rotating the drill string from the surface of the formation, or the drill bit may be rotated by coupling the drill bit to a downhole motor, as referenced above. The downhole motor may comprise, for example, a hydraulic Moineau-type motor having a shaft, to which the drill bit is mounted, that may be caused to rotate by pumping fluid (e.g., drilling mud or fluid) from the surface of the formation down through the center of the drill string, through the hydraulic motor, out from nozzles in the drill bit, and back up to the surface of the formation through the annular space between the outer surface of the drill string and the exposed surface of the formation within the wellbore.

During or after drilling of a wellbore, it may be desirable to produce images (e.g., high-resolution images) of a wellbore to determine one or more properties of a subterranean formation surrounding a wellbore in which the drill string is disposed. However, producing such high-resolution images while decreasing imaging processing requirements is challenging using conventional means.

### BRIEF SUMMARY

Embodiments disclosed herein include a downhole imaging system that includes an imaging device operably coupled to a member of a drill string and configured to generate an image of a subterranean formation from within a wellbore, and a processor operably coupled to the imaging device. The imaging device includes a sensor comprising a transmitter and a receiver, and a coding mask located between the sensor and the subterranean formation.

In additional embodiments, a downhole assembly includes at least a portion of a drill string and a sensor coupled to a component of the at least a portion of the drill string. The sensor is located and configured to transmit and receive signals between the sensor and a subterranean formation from within a wellbore. The downhole assembly also includes a coding mask comprising a volume of material having a varying thickness. The coding mask is configured to provide a compressed measurement of individual data points obtained from the signals transmitted and received with the sensor. Further, the downhole assembly includes a processor operably coupled to the sensor. The processor is configured to compile an image of the subterranean formation based on the compressed measurement of the individual data points.

In further embodiments, a method of generating an image of a subterranean formation in a wellbore includes conveying a bottom-hole assembly in the wellbore, the bottom-hole assembly comprising an imaging device including a sensor comprising a transmitter and a receiver, moving the sensor in the wellbore, transmitting a wave using the transmitter, receiving a first individual image and a second individual image using the receiver. The second individual image comprises an overlap region with the first individual image. The method includes generating the image using a mathematical algorithm, the first individual image, the second individual image, and the overlap region. Transmitting the wave comprises breaking a phase uniformity of the transmitted wave.

### BRIEF DESCRIPTION OF THE DRAWINGS

FIG. 1 is a simplified, schematic illustration of a downhole drilling system including a downhole imaging system, in accordance with an embodiment of the disclosure;

FIG. 2A is a schematic block diagram illustrating the downhole imaging system in accordance with embodiments of the disclosure; and

FIG. 2B is a portion of a schematic diagram of the downhole imaging system of FIG. 2A.

### DETAILED DESCRIPTION

Illustrations presented herein are not meant to be actual views of any particular downhole imaging system, downhole assembly, component or device of such a system or assembly, or material, but are merely idealized representations that are employed to describe embodiments of the disclosure. Additionally, elements common between figures may retain the same numerical designation.

The disclosure includes downhole imaging systems for producing high-resolution images of a wellbore to determine one or more properties of a subterranean formation during drilling, reaming, or logging operations. Such downhole imaging systems may include an imaging device including a sensor (e.g., an acoustic emission transducer) and a coding mask also referred to as an aperture mask, compressive coding mask, spatial modulator mask, or compressive sampling filter. The aperture mask may include or, alternatively, be covered with a polymer material suitable for downhole conditions. The imaging device may be configured to produce two-dimensional (2D) or three-dimensional (3D) high-resolution images using compressive sensing techniques.

As used herein, “drilling system” means and includes any grouping of inter-communicable or interactive tools configured for use in testing, surveying, drilling, completing, sampling, monitoring, utilizing, maintaining, repairing, etc., a bore. Drilling systems include, without limitation, on-shore systems, off-shore systems, systems utilizing a drill string, and systems utilizing a wireline.

As used herein, the term “downhole tool” means and includes any tool used within a wellbore in a subterranean formation. Downhole tools include, without limitation, tools used to measure or otherwise detect conditions in the downhole environment and tools used to communicate conditions to uphole locations.

As used herein, the term “wear-resistant material” means and includes a material exhibiting enhanced resistance to at least one of abrasive wear and erosive wear and includes any material exhibiting a Vickers hardness of 1700 HV or greater.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter.

As used herein, the term “between” is a spatially relative term used to describe the relative disposition of one material or region relative to at least two other materials or regions, respectively. The term “between” can encompass both a disposition of one material or region directly adjacent to the other materials or regions, respectively, and a disposition of one material or region not directly adjacent to the other materials or regions, respectively.

As used herein, “and/or” includes any and all combinations of one or more of the associated listed items.

As used herein, the term “compressive sensing” means and includes a signal processing technique for efficiently acquiring and reconstructing a signal by finding solutions to underdetermined linear systems. Compressive sensing processes allow compression of signals (e.g., acoustic signals) to be merged with sensing processes by projecting the signal information through a set of incoherent functions onto a single compressed measurement. For example, an aperture mask having local variations in a mask thickness may be utilized to ensure that each surface or volume pixel (e.g., voxel) in an imaged surface or volume (e.g., 2D or 3D) is uniquely identifiable in the compressed measurement. The unique surface or volume pixel signature enables direct imaging without the need for uncompressed spatial measurements.

As used herein, the term “sensor” means and includes a device that responds to a physical condition. For example, sensors may be configured to detect sound waves, electromagnetic fields, radioactive particles, magnetic fields, electric fields, pressures, flow rates, temperatures, etc., and may be configured to communicate with other parts of a system, such as a processor (e.g., a control system) associated with a drill string. In some embodiments, a “sensor” may also include, without limitation a transmitter, providing a transceiver, such as a sound wave or acoustic transceiver. The sensor may be a piezoelectric receiver. The sensor, including a receiver and transmitter, may use a piezoelectric crystal (e.g., piezoelectric transmitter, piezoelectric receiver) and may be a piezoelectric transceiver configured to transmit and detect (e.g., receive) acoustic waves.

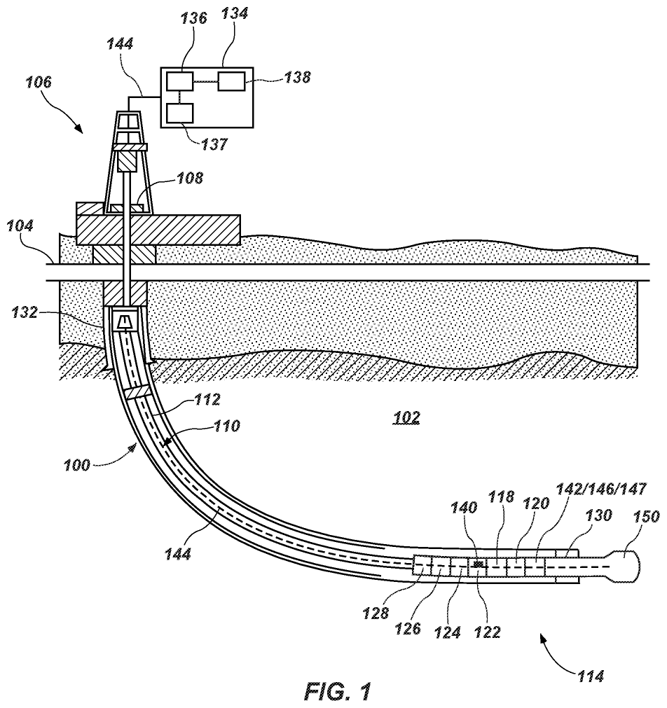

FIG. 1 is a simplified, schematic representation showing a wellbore 100 formed in a formation 102. One or more sections of the wellbore 100 may include one or more sections of casing 132 disposed therein. The wellbore 100 may be a partially formed wellbore 100 that is currently undergoing further drilling to extend a depth of the wellbore 100, as well as enlargement of a diameter of the wellbore 100, as illustrated in FIG. 1. Thus, a drilling system 106 used to form the wellbore 100 may include components at a surface 104 of the formation 102, as well as components that extend into, or are disposed within the wellbore 100. The drilling system 106 includes a rig 108 at the surface 104 of the formation 102, and a drill string 110 extending into the formation 102 from the rig 108. The drill string 110 includes a tubular member 112 that carries a bottomhole assembly (BHA) 114 at a distal end thereof. The tubular member 112 may be made up by joining drill pipe sections in an end-to-end configuration.

The bottomhole assembly 114 may include, as non-limiting examples, a drill bit 150, a steering device 118 (e.g., a rotary steerable device), a drilling motor 120, a sensor sub 122, a bidirectional communication and power module (BCPM) 124 (e.g., a mud pulser), a stabilizer 126, a formation evaluation (FE) module 128 (Logging While Drilling (LWD) device), an operational data sensor module (Measurement While Drilling (MWD) device), and a hole enlargement device 130. The drill bit 150 may be configured to drill, crush, abrade, or otherwise remove portions of the formation 102 during formation of the wellbore 100. The drill bit 150 may include a fixed-cutter earth-boring rotary drill bit (also referred to as a “drag bit”), a rolling-cutter earth-boring rotary drill bit including cones that are mounted on bearing pins extending from legs of a bit body such that each cone is capable of rotating about the bearing pin on which the cone is mounted, a diamond-impregnated bit, a hybrid bid (which may include, for example, both fixed cutters and rolling cutters), and any other earth-boring tool suitable for forming the wellbore 100.

The bottomhole assembly 114 (BHA) or parts of the BHA may be rotated within the wellbore 100 using the drilling motor 120. The rotation provided by the drilling motor is a motor rotation measured in motor revolutions per minute (motor RPM). The drilling motor 120 may comprise, for example, a hydraulic Moineau-type motor having a shaft (e.g., a rotor), to which the bottomhole assembly 114 is coupled, that may be caused to rotate by pumping fluid (e.g., drilling mud or fluid) from the surface 104 of the formation 102 down through the center of the drill string 110 (e.g., within an inner bore), through the drilling motor 120, out through nozzles in the drill bit 150, and back up to the surface 104 of the formation 102 through an annular space (e.g., annulus) between an outer surface of the drill string 110 and an exposed surface of the formation 102 within the wellbore 100 (or an exposed inner surface of any casing 132 within the wellbore 100). Alternatively, the bottomhole assembly 114 may be rotated within the wellbore 100 by rotating the drilling system 106 from the surface 104 of the formation 102. The rotation from the surface may be provided by a top drive or a rotary table and is measured in surface revolutions per minute (surface RPM). A BHA component located above the motor rotates in the wellbore with the surface RPM. A BHA component located below the motor rotates in the wellbore with the surface RPM plus the motor RPM. While drilling the borehole the drill string 110 and the bottomhole assembly 114 progresses into the wellbore with a certain rate of penetration (ROP).

One or more sections of the drill string 110 may include one or more imaging devices 140 for use during drilling of the wellbore 100, after the drilling of the wellbore 100, or both. The one or more imaging devices 140 may be provided on one or more sections of the drill string 110, such as on one or more sections of the tubular member 112, one or more section of the bottomhole assembly 114, or combinations thereof. In some embodiments, the imaging devices 140 may be coupled to or disposed within the drill bit 150, the hole enlargement device 130, or one or more other sections of the bottomhole assembly 114, such as on a drill collar, the stabilizer 126, a reamer (e.g., the hole enlargement device 130), a bit sub, the steering device 118, a LWD or MWD device, or other tool or component of the bottomhole assembly 114.

The imaging devices 140 may be attached to different components of the bottomhole assembly 114. For example, the imaging devices 140 may be located within openings (e.g., apertures, recesses, etc.) and may be located near an exterior surface of a component of the bottomhole assembly 114. In some embodiments, the imaging devices 140 may be located inside a collar of a BHA. In other embodiments, the imaging devices 140 may be located inside the inner bore of the BHA. In some embodiments, a single imaging device 140 including one or more sensors may be attached to a component of the bottomhole assembly 114. In other embodiments, two or more (e.g., an array of) imaging devices 140 may be coupled to different sections of the BHA (e.g., a drill pipe) of the drill string 110. In such an embodiment, the imaging devices 140 may be axially spaced a predetermined distance from one another along, for example parallel to, a longitudinal axis of the drill string 110, the BHA, or the drill bit 150. A single imaging device 140 may comprise a plurality of sensors spaced circumferentially around the longitudinal axis of the imaging device 140, spaced axially along the longitudinal axis of the imaging device 140, or combinations thereof.

The imaging device 140 may be located and configured to produce images (e.g., high-resolution 2D or 3D images) of the wellbore 100. Such images may be used to determine one or more properties of the formation 102 (e.g., type of lithology, porosity, pore space, pore size, sound speed, permeability, conductivity, resistivity, density, etc.) or to determine structural properties of the subterranean formation (e.g., faults, fractures, boundaries, dip angles, etc.). For example, each of the imaging device 140 may be configured to transmit and receive signals (e.g., acoustic signals) to be converted to an electronic signal, such as, for example, a voltage or a current. As described herein, the electronic signal may be used to produce images of the wellbore 100.

The imaging device 140 may be in electrical communication with one or more controllers, such as one or more of a surface controller 134. The surface controller 134 may be placed at or above the surface 104 for receiving and processing downhole data. The surface controller 134 may include a processor 136, such as a microprocessor or microcontroller, and may also include processor-readable or computer-readable program code embodying logic, including instructions for controlling the function of the imaging devices 140. The surface controller 134 may also include a storage device 137 (e.g., a memory) for storing data and computer programs, and an electronic display 138 for displaying one or more images of the wellbore 100. The processor 136 accesses the data and programs from the storage device 137 and executes the instructions contained in the programs to control the drilling system 106 during drilling operations, to control the imaging devices 140, and to generate (e.g., collect and/or reconstruct) images of the wellbore 100. The surface controller 134 may also include other controllable components, such as additional sensors, data storage devices, power supplies, timers, and the like. The surface controller 134 may also be disposed to be in communication with various sensors and/or probes for monitoring physical parameters of the wellbore 100, such as a gamma ray sensor, a depth detection sensor, an accelerometer, or a magnetometer.

A downhole controller 142 may be in electrical communication with the imaging device 140. The downhole controller 142 may be placed within the wellbore 100 for receiving and processing downhole data, for example in a component of the bottomhole assembly 114. The downhole controller 142 may also include a processor 146 (e.g., a microprocessor), storage devices 147 (e.g., memory) for storing data, and computer programs. Further, the downhole controller 142 may also optionally communicate with other instruments in the drill string 110 or drilling system 106, such as a telemetry system that communicates with the surface controller 134. The downhole controller 142 may be configured to receive electrical signals from the imaging device 140. In some embodiments, the downhole controller 142 is configured to receive the electronic signals from more than one imaging device 140. The downhole controller 142 may be configured to condition, filter, amplify, or otherwise process the electronic signals from the imaging device 140, as described herein.

The downhole controller 142 may be configured to communicate data with the surface controller 134 and thus, may be in electrical communication with the surface controller 134. In some embodiments, the imaging device 140, the downhole controller 142, and the surface controller 134 communicate with each other via a communication interface 144. The communications interface 144 may include a wireline configured to transmit the data to and from the surface 104, wireless communications, electrical cables or fiber optic cables extending through a wall of drill string components, mud pulse telemetry (e.g., a mud pulser), or other method suitable for transferring data and signals to and from the imaging device 140, the downhole controller 142, and the surface controller 134.

The communication interface 144 may extend along an interior of the drill string 110 (such as an interior of the tubular member 112), similar to a wireline, as is known to those of ordinary skill in the art, and may run into the drill string 110 as desired, or may be permanently deployed within the drill string 110 (e.g., a wired pipe). Although the communication interface 144 is illustrated as extending along an interior of the drill string 110, the communication interface 144 may be located at any suitable location within the wellbore 100 relative to the drill string 110. For example, the communication interface 144 may run along an exterior of the drill string 110, or comprise part of a self-contained sensor package in the bottomhole assembly 114 configured for wireless communication. Although the signal processing circuitry has been described herein with respect to the downhole controller 142, the drilling system 106 may not include the downhole controller 142 and may include, for example, only the surface controller 134. While the embodiment of the drilling system 106 including the imaging device 140 is illustrated with reference to drilling applications, such an application is shown for illustrative purposes only. The imaging device 140 may alternatively be used in wireline applications including, for example, pure logging applications (e.g., a logging tool deployed into a wellbore using a wireline) without utilizing a drill string of a drilling operation.

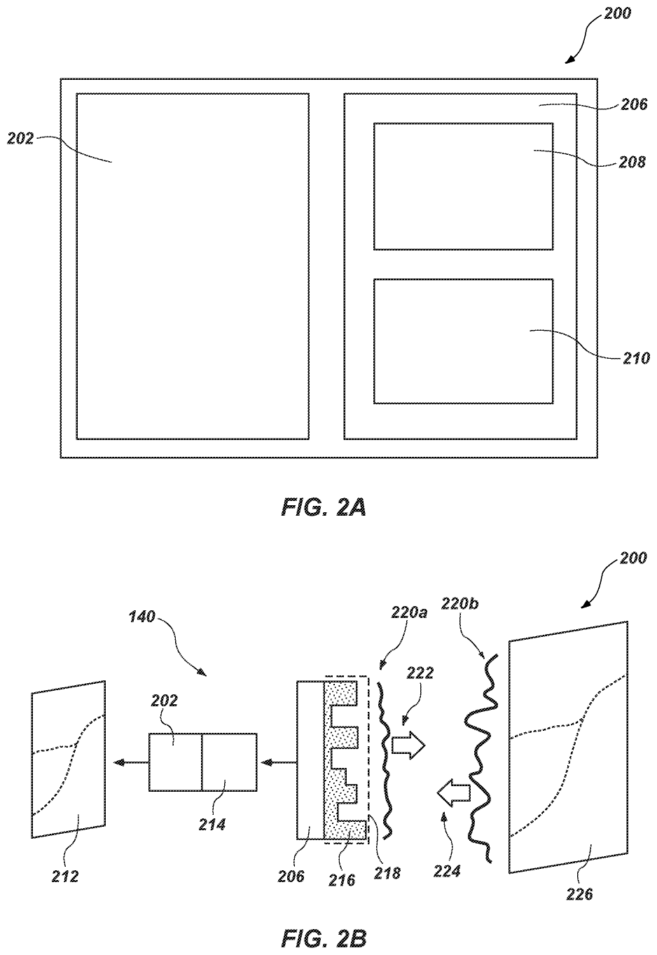

FIG. 2A is a schematic block diagram of an illustrative downhole imaging system 200 according to an embodiment of the disclosure. As shown in FIG. 2A in combination with FIG. 2B, the downhole imaging system 200 may include at least one data processing unit 202, which may include signal processing circuitry as well as other devices and/or systems that enable collection, processing, storing, and/or displaying images of the wellbore 100 (FIG. 1). The downhole imaging system 200 also includes a sensor 206 (e.g., an acoustic emission transducer) including a transmitter 208 and a receiver 210. In some embodiments, the transmitter 208 and the receiver 210 may be separate devices, as depicted in FIG. 2A. In other embodiments, the transmitter 208 and the receiver 210 may be combined into one device (e.g., a transceiver) that both generates and receives a signal (e.g., an acoustic signal, an optical signal, an electromagnetic signal). The sensor 206 of the imaging device 140 may be a condition-sensing component of an acoustic sensor, e.g., a piezoelectric transducer, generally or, more specifically, a piezoelectric ceramic transducer. The sensor 206 generates a signal in response to applied electric energy (e.g., acoustical energy) and may include, for example, acoustic wave sensors that utilize piezoelectric material, magnetostrictive sensors, accelerometers, a hydrophone or other suitable sensors for detecting acoustic emissions. In some embodiments, the imaging devices 140 comprise a hydrophone coupled to fiber optics including fiber bragg gratings configured to measure acoustic properties of the acoustic emissions. Although the sensor 206 has been described herein with respect to acoustical signals, the sensor 206, including the transmitter 208 and the receiver 210, may not be configured to transmit and receive acoustical signals and may be configured, for example, to transmit and receive other types of signals (e.g., optical, resistivity, x-ray, gamma, electric, magnetic, electromagnetic, neutron, nuclear magnetic resonance (NMR), thermal, etc.).

The data processing unit 202 may include one or more electronics modules, including the downhole controller 142 of FIG. 1, and may include conventional electrical drive voltage electronics (e.g., a high voltage, high frequency power supply) for applying a waveform (e.g., a square wave voltage pulse, a sinusoidal wave, or a Ricker wavelet) to a piezoelectric ceramic transducer, which causes the transducer to vibrate and thus launch a pressure pulse into the drilling fluid external to a downhole tool. The data processing unit 202 may also or alternatively include receiving electronics, such as a variable gain amplifier for amplifying a relatively weak received signal (as compared to the transmitted signal). The receiving electronics within the electronics module may also include various filters (e.g., low and/or high pass filters, Kalman filters), rectifiers, multiplexers, and other circuit components for processing the detected signal. In some embodiments, at least a part of the processing of the received signal is performed at the surface 104 (FIG. 1). In some such embodiments, the received data may be transmitted to the surface controller 134.

The sensor 206 is fixed to the imaging device 140 and rotates either with surface RPM or with surface RPM plus motor RPM within the wellbore 100 (FIG. 1). At the same time, the sensor 206 progresses into the wellbore 100 as the drill string 110 (FIG. 1) penetrates the formation 102 (FIG. 1) with the rate of penetration (ROP). The sensor 206 (e.g., a single sensor) may move along a spiral curve in the wellbore 100, such that an axis of the spiral curve is a longitudinal axis of the imaging device 140 or, alternatively, the longitudinal axis of the wellbore 100. The spiral curve of the sensor 206 may have a pitch that depends at least in part on the ROP of the drill string 110. In embodiments of the imaging device 140 including more than one sensor 206, each sensor 206 will individually move along a spiral curve in the wellbore 100, such that each of the spiral curves has substantially the same pitch with a different start point. An image generated by the imaging device 140 may include a 360-degree image of the borehole wall (e.g., the formation 102) surrounding the wellbore 100 along the spiral curve. Two loops in a spiral image may or may not overlap, depending at least in part on the ROP of the drill string 110.

The imaging device 140 (e.g., a conventional imaging device) may record a single value for a single measurement. The single value may be based on properties of the received signal detected by the sensor 206 such as, for example, amplitude, travel time, counts per second, electric current, electric field strength, magnetic field strength, or electromagnetic field strength. Each single measurement may provide a pixel of the image (e.g., an image pixel) along the spiral curve. The image pixel may result from a short-signal burst transmitted by the transmitter 208. The short-signal burst may be only a few signal cycles (e.g., two periods) in duration. In some embodiments, the short-signal burst may be used to provide a specific bandwidth (e.g., a Ricker wavelet). The short-signal burst may travel through the drilling mud in the annulus of a drill string, for example, and may undergo interaction (e.g., reflections) with a borehole wall or with structures in the surrounding formation 102. Thereafter, modified signals may be received by the receiver 210. By way of non-limiting example, a size of an individual image may be in the range of one square centimeter (e.g., 1 cm²) to a few square centimeters (e.g., 2 cm² to 5 cm²). While rotating and progressing the drill string 110 within the wellbore 100, a final image may be formed by stringing together single values of the individual images along the spiral curve to form a spiral image and by combining individual loops of the spiral image. The final image may represent an image of the borehole wall along the wellbore 100 (2D), an image of the formation 102 around the wellbore 100 (3D), or a slice of the formation 102 (2D). To combine (e.g., string together) the individual images, the location of the sensor 206 in the wellbore 100 at the time of the transmission of the short-signal burst, the location at the time of the reception of the modified short-signal burst, or combinations thereof may be used. Spatial coordinates (e.g., azimuth, depth, tool face, etc.) of the imaging device 140 may be used to determine the location of an individual image. The generation of the final image from the individual images may be performed at the surface 104 since the depth of the imaging device 140 at the time of the reception of the individual image is known at the surface 104. Further, the depth information may be associated with an uncertainty since the depth of the imaging device 140 may be recorded through the length of the drill string 110 (e.g., the drill pipes) in the wellbore 100. Therefore, the depth of the imaging device 140 may be subjected to uncertainties based at least in part on pipe stretch, wellbore sagging, and other factors affecting the accuracy of the depth determination through the length of the drill string 110. For example, the accuracy of the depth of the imaging device 140 during acquisition of an individual image may depend at least in part on the type of the wellbore 100 that is drilled while the image is recorded, such as vertical wellbores, deviated wellbores, or horizontal wellbores.

FIG. 2B is a portion of a schematic block diagram of the downhole imaging system 200 of FIG. 2A. The downhole imaging system 200 may result in one or more individual images 212 (e.g., high-resolution 2D or 3D images). The individual images 212 may be converted (e.g., digitized) using a converter 214 that is operably associated with the sensor 206 and the data processing unit 202. The converter 214 may include, for example, an analog-to-digital converter (ADC), as is known in the art. The converter 214 receives data in the way of an analog signal (e.g., an acoustic signal) from the sensor 206 and provides a digital representation to components of the data processing unit 202. Among other elements, the imaging device 140 may include the sensor 206, including the transmitter 208 and the receiver 210 or, alternatively, a transceiver. In the transceiver, the transmitter 208 and the receiver 210 may be only one (e.g., a single) device. Stated another way, the transmitter and the receiver are the same device. An aperture mask 216 may be used in combination with the sensor 206. The aperture mask 216 may be located between the operating surface of the sensor 206 and the formation 102 (FIG. 1) of interest such that signals transmitted and received by the sensor 206 pass through the aperture mask 216. In some embodiments, the aperture mask 216 may be coupled to (e.g., affixed directly to) an external surface of the sensor 206 and may completely cover an operating surface (e.g., an active surface or an area) of the sensor 206. The aperture mask 216 may, for example, be clamped, screwed, glued, welded, press fitted, or otherwise affixed to the sensor 206. In other embodiments, the aperture mask 216 may be integrally formed with or merely associated with (e.g., located in proximity to) the sensor 206, such as, for example, on an exterior surface of a housing of the sensor 206 or on a component of the downhole tool, such as a housing hosting the sensor 206. The aperture mask 216 may, therefore be exposed to downhole drilling conditions including high temperatures (e.g., at least about 150° C.) as well as high pressures (e.g., 30,000 psi). Thus, the aperture mask 216 may include or, alternatively, be covered with a polymer material 218, as described in greater detail below. In operation, the sensor 206 may be configured to generate a transmitted signal 222 and to obtain a received signal 224, such as a transmitted wave 220a (e.g., a burst) transmitted to and a received wave 220b received from a subterranean formation surface or volume 226, such as a borehole wall (2D), of the wellbore 100 (FIG. 1) or a subterranean formation surrounding the wellbore 100 (3D). The received signal 224 with the received wave 220b carries information about the surface or volume 226 and/or the information about the formation 102 (FIG. 1). The transmitted signal 222 interacts with the surface or volume 226 and/or the formation 102, by adsorption, reflection, scattering, or refraction, for example. The interaction of the transmitted signal 222 with the surface or volume 226 and/or the formation 102 provides a modified signal, the received signal 224, that may be received by the receiver 210.

During drilling, reaming, or servicing (e.g., logging) operations of the wellbore 100, for example, the individual images 212 may be produced as a result of the received signal 224, in the form of the received wave 220b, exhibiting an amplitude, a frequency, and a phase that are detectable by the receiver 210 of the sensor 206. A suitably programmed processor, such as the processor 136 (e.g., at the surface 104 (FIG. 1)) or the processor 146 (e.g., downhole), may be used to produce one or more of the individual images 212 using the digitized signal from the converter 214. Further, the data processing unit 202 may be configured to cause the processor 136 or the processor 146 to reconstruct (e.g., to stitch) the individual images 212 into a set (e.g., a series) of individual images, providing an image of the surface or volume 226 and/or the formation 102 (2D or 3D), which may be used to determine one or more properties of surface or volume 226 and/or the formation 102. For example, the sensor 206 provides information relating to a condition of the surface or volume 226. In particular, the imaging device 140 provides the individual image 212 of the surface or volume 226 and surrounding formation including size, shape, and structure of the formation 102. By varying the frequency of the transmitted signal 222, the depth of investigation to which the signals penetrate the formation can be varied and the imaging device 140 may be used to determine structures (e.g., dips, faults, fractures, breakouts, dip angles, etc.) within the surface or volume 226 or the surrounding subterranean formation. Further, compressive sensing techniques may be utilized to obtain and process the received signal 224 in order to generate the individual images 212 based on compressed information comprised in the received signal 224. In conventional systems, images of the borehole wall or the subterranean formation are typically generated by collecting and assembling individual images with each individual image including one individual image pixel. In such systems, the highest resolution of the image that can be achieved is the number of individual images. In other words, the number of assembled individual images equals the number of image pixels. Such images require exact knowledge of the spatial position each individual image was obtained at and, thus, require information regarding the rotation angle and depth of a downhole tool for each individual image. Compressive sensing techniques, on the other hand, allow compression of signals (e.g., acoustic signals) to be merged with the sensing processes by projecting the signal information through a set of incoherent functions onto a single compressed measurement.

For example, the aperture mask 216 having local variations in thickness may be utilized to ensure that signal responses of each location (e.g., each surface pixel or volume pixel (voxel)) in the surface or volume 226) is uniquely identifiable. The signal response from each location in the imaged surface or volume 226 (e.g., reflected acoustic wave) contains a unique signal signature in the compressed measurement. Thus, each individual measurement generates an individual image 212 (2D or 3D) of the imaged surface or volume 226 with multiple individual image pixels. Different to an individual image generated without the aperture mask 216 and without compressive sensing, the individual image 212 generated with compressive sensing and the aperture mask 216 comprises structural details of the imaged surface or volume 226 enabled by the coding of the transmitted signal 222 by the aperture mask 216. For an embodiment with the transmitter 208 and the receiver 210 being the same device (e.g., a transceiver), the coding performed by the aperture mask 216 is applied to the transmitted signal 222 and the received signal 224. While the individual image generated by an individual measurement of a conventional imaging device comprises only one individual image pixel, the individual image 212 generated using the compressive sensing method including the aperture mask 216 generates an individual image 212 comprising multiple individual image pixels (2D or 3D) leading to a higher content of information, which may be used to align the individual images 212 to generate an image of the surface or volume 226 or the formation 102. The 2D or 3D individual images partially overlap one another such that the generated individual images 212 may be reconstructed (e.g., stitched) into a large mosaic to form the image, without the need to collect and utilize exact location information (e.g., rotation angle (azimuth and/or tool face) and depth of the imaging device 140 in the wellbore 100) of the downhole tool for each individual image 212 at the time of the individual measurement. Stated another way, the image may be produced (e.g., collected and reconstructed) without using spatial coordinates. The generation of the image is possible due to the overlapping structural information in each individual image 212 provided by the compressive sensing using the aperture mask 216. In some embodiments, location data (e.g., spatial coordinates) of the imaging device 140 may be recorded for use in analyzing information contained within the image. However, such location data is not used to reconstruct the location of the individual images 212 in the image. Rather, such stitching processes in combination with compressive sensing techniques allow the imaging device 140 to sum the individual images 212 after the transmitted signal 222 and the received signal 224 of the individual measurement have passed through the aperture mask 216. The alignment of the individual images acquired using compressive sensing techniques may use stitching processes (e.g., mathematical algorithms) well known in the art. Stitching processes may, for example, make use of the Fourier Shift Theorem, error metrics, hierarchical motion estimation, incremental refinement, parametric motion, or combinations thereof, as is known in the art of signal processing. Such processes compute all possible translations (x, y) between two 2D or 3D images at once. In some embodiments, the stitching processes may be performed (e.g., exclusively performed) in the time domain. Thus, information obtained in the spatial domain may be transformed into the time domain for processing prior to reconstruction of the image in the spatial domain.

Stitching algorithms may be used to combine two or more of the individual images 212. The individual images 212 may be combined using the stitching algorithm in the order they are received (e.g., along a spiral curve) by the sensor 206. The stitching algorithm may first combine overlapping individual images 212 taken at different rotation angles. After completing a 360-degree spiral loop, overlapping the individual images 212 from different spiral loops may be stitched together. Individual images 212 may be stitched to other individual images 212 that are located proximate (e.g., left, right, above, below) one another. Accordingly, one individual image 212 may be stitched to various neighboring overlapping individual images 212. Rather than stitching single individual images 212 to one another, groups of images may be stitched together. For example, the individual images 212 may first be stitched to form a spiral loop of the image. The spiral loop of the image may then be stitched to another overlapping spiral loop of the image to form an image from two or more spiral loops. In some embodiments, all individual images 212 are stitched in one (e.g., a single) stitching process. Using stitching algorithms allows the generation of an image from the individual images 212 (e.g., individual measurements) without using information related to the depth of the imaging device 140 within the wellbore 100. Further, the information related to the angle of rotation (e.g., azimuth and/or tool face) may be made redundant by using stitching algorithms. Generation of an image without depth information allows image generation downhole when the depth information of the imaging device 140 is not available. Having the image available downhole and having the information (e.g., dig angle) provided by the image available downhole allows for decision making during drilling operations and for automated drilling operations. The theory of stitching is described in detail, for example, in an article titled “Image alignment and stitching: A tutorial,” by Richard Szeliski, Foundation and trends in computer graphics and vision, Vol. 2, No. 1 (2006), pp. 1-104, the disclosure of which is incorporated herein in its entirety by this reference.

A material (e.g., the polymer material 218) used to form the aperture mask 216 may be characterized by its acoustic properties. For example, the material of the aperture mask 216 may be formulated to detect signals (e.g., a speed of sound) transmitted therethrough. In non-limiting embodiments, the aperture mask 216 is formed from a solid material. However, other types of materials (e.g., fluids, gels, elastomers) may be suitable. Based on an acoustic velocity through variable thicknesses (e.g., height) of material of the aperture mask 216, a modulation of the phase of the acoustic wave occurs. For example, the aperture mask 216 may be used to selectively retard (e.g., slow down) the propagation of portions of the transmitted signal 222 generated by the transmitter 208 of the sensor 206. Stated another way, the propagation speed of the acoustic wave differs depending on the location that the acoustic wave passes through the aperture mask 216. The varying propagation speeds may result in coding of the phase of the acoustic wave. The phase uniformity of the propagating wave is broken, initiating a random deterministic interference pattern of the acoustic wave in the imaged surface or volume 226 (e.g., (e.g., borehole wall or the formation 102, respectively). Thus, the phase of the acoustic wave may depend on the location in the aperture mask 216 the acoustic wave passed through. The aperture mask 216 may provide a location dependent incoherence pattern of the transmitted acoustic wave in the imaged surface or volume 226. The aperture mask 216 may also be used to selectively retard (e.g., slow down) the propagation of portions of the received signal 224. Further, the phase of the acoustic wave may be coded a second time upon return to the receiver 210, increasing the incoherence of acoustic signals reflected at different locations in the imaged surface or volume 226. Variation of propagation speed for different portions of the transmitted signal 222 may create a complex spatiotemporal interference pattern that ensures that each imaged surface or volume pixel generates a unique temporal signal in the compressed measurement. Thus, information obtained in the spatial domain is transformed into the time domain. Upon reception of the received signal 224 at the receiver 210, signal (e.g., data) processing performed by the processor 136 and/or the processor 146 transfers the information in the time domain back into the spatial domain to achieve the individual images 212. In particular, varying the thickness of the aperture mask 216 varies the time the signal (e.g., acoustic wave) spends within the material of the aperture mask 216 before arriving at the imaged surface or volume 226. Further, the individual images 212 may be obtained using only a single sensor 206. Stated another way, a lone signal may be processed using compressed measurements to obtain the individual images 212. In some embodiments, the aperture mask 216 may be rotated relative to the sensor 206, such that the interference pattern is rotated relative to the sensor 206. In such embodiments, rotation of the aperture mask 216 during operation may result in greater incoherence leading to enhanced high-resolution images due to increased diversity of signals from the imaged surface or volume 226. Additionally, or alternatively, a translational movement of the aperture mask 216 relative to the sensor 206 may be performed. In other embodiments, the aperture mask 216 may not be rotated and/or translated and may be stationary relative to the sensor 206.

Compressive sensing may utilize (e.g., exploit) natural structure (e.g., sparse data) of the image. The natural structure may include, for example, a location, slope of a fault or fracture, a dig angle, or a specific lithology. Further, the compressive sensing process may be improved (e.g., optimized) during use and operation thereof. In some embodiments, calibration (e.g., training) of the compressive sensing process may be performed at a surface location. In alternative embodiments, the calibration may be performed downhole. The calibration may use data sets of images with known structures, such as data from a high resolution wireline imaging performed in an offset wellbore of the given field with a given type of subterranean formation and similar structures in the formation 102, such as similar fractures, faults, and/or boundaries. Alternatively, samples such as rock cores or other pieces of a subterranean formation with known properties may be used for the calibration. In some embodiments, the compressive sensing process may be improved using a sample created artificially (e.g., using 3D printing). For the calibration, the sample may be passed along the imaging sensor to simulate the movement (e.g., rotation and penetration movement) of the sensor 206 within the wellbore 100. The calibration may then be used to improve the compressive sensing process. The theory of compressive sensing and the effect of an aperture masks and associated processes are described in detail, for example, in an article titled “Compressive 3D ultrasound imaging using a single sensor” by Kruizinga et al., Sci. Adv. 2017; 3:e1701423, published 8 Dec. 2017, the disclosure of which is incorporated herein in its entirety by this reference.

The aperture mask 216 comprises dimensions including a length, a width, and a height (e.g., thickness). The length and the width may be defined as dimensions substantially perpendicular to a propagation direction of the transmitted signal (e.g., acoustic wave). The height (thickness) of the aperture mask 216 may be defined as a dimension substantially parallel to the propagation direction of the signal. The aperture mask 216 may be planar or may be curved, e.g., correspond to a cylindrical surface of the imaging device 140. It is to be understood that for the transmitter 208 having a radial transmission, at least portions of the transmitted signal 222 may not propagate through the aperture mask 216 parallel to the height dimension. Further, the length and the width (e.g., lateral dimensions) of the aperture mask 216 may exhibit a substantially rectangular cross-sectional shape (e.g., a substantially square cross-sectional shape) or a substantially circular cross-sectional shape including a radius. A contour of the aperture mask 216 may align with a contour of one or more of the sensor 206, the transmitter 208, or the receiver 210. The aperture mask 216 may cover (e.g., entirely cover) the active area of the sensor 206. A cross-sectional area of the active area of the sensor 206 may be a few centimeters in diameter (e.g., 2 cm) or may be a few cm in each lateral dimension (e.g., 2 cm in length and 2 cm in width). Dimensions (e.g., thicknesses) of the aperture mask 216 may be determined according to a frequency, amplitude of the transmitted wave 220a of the transmitter 208 and the received wave 220b of the receiver 210, and the desired level of incoherence of the portions of the transmitted wave 220a and the received wave 220b. A thickness of the aperture mask 216 varies locally, providing multiple thicknesses in the aperture mask 216. By way of non-limiting example, thicknesses of the aperture mask 216 for an acoustic sensor may vary between about 0.1 mm and about 10 mm, such as between about 1 mm and about 5 mm. Further, adjacent portions of the aperture mask 216 having the varied (e.g., differing) thicknesses, may horizontally overlap one another with a maximum overlap of between about 0.1 and about 0.5 mm between portions of varied thicknesses.

Increasing a number of portions (e.g., regions) having differing thicknesses relative to one another may result in the aperture mask 216 exhibiting an increased number of incoherence of portions of the signal (e.g., acoustic wave) of the transmitted wave 220a and the received wave 220b. In some embodiments, the aperture mask 216 may comprise an infinite number of regions with varying thicknesses. In alternative embodiments, the aperture mask may comprise from about 2 to about 10,000, from about 2 to about 1,000, from about 2 to about 100, from about 2 to about 10, or from about 2 to about 5 regions with varying thickness. The transmission between the regions of varying thicknesses in the aperture mask 216 may be continuous (e.g., gradual, tapered) or may be stepwise, including a step in thickness between regions with varying thicknesses. There may be more than one region with the same thickness within the mask. Regions with the same thickness may be separated from each other by one or more other regions with differing thicknesses. Regions with same thickness do not abut with one another. In some embodiments, the variation in thicknesses may be random (e.g., non-uniform). For example, the regions with varying material thicknesses may form a random or chaotic spatial pattern in the aperture mask 216. In alternative embodiments, regions with varying thicknesses may form a regular spatial pattern in the aperture mask 216. Regions with differing thicknesses in the aperture mask 216 may have an angular contour (e.g., polygon, triangle, square, octagon, etc.) or may have a curved contour (e.g., circle, oval, ellipse, etc.). Alternatively, the regions with the varying thicknesses may have continuous transitions from one thickness to another thickness. Further, the transmitter 208 of the sensor 206 may be configured to transmit signals having a frequency of between about 50 kHz and about 1 MHz, such as about 100 kHz. Of course, a person of ordinary skill in the art would recognize that use of other sensors (e.g., optical, x-ray, etc.) that transmit and receive another type of signal, with an associated wavelength and amplitude, would result in differing ranges of varying thicknesses of the aperture mask 216 as well as differing frequencies of the transmitted signal 222.

Further, conditions in a downhole environment are often harsh. Sensors used downhole must typically withstand temperatures ranging to and beyond 150° C. and pressures ranging up to about 30,000 psi. Surrounded by earth formation, debris, and drilling mud, downhole conditions are often also moisture-filled spaces, yet, sensors may have sensitive components that can be damaged when coming into contact with fluids. For example, in an acoustic sensor employing a piezoelectric transducer including a ceramic material. Exposure of the ceramic material to moisture at high pressures and temperatures makes the ceramic material vulnerable to water diffusion therein, which may alter the capacitance and the dielectric constant of the ceramic material. Such alterations compromise the sensor's ability to detect signals accurately.

In some embodiments, the aperture mask 216 may be formed of (e.g., formed entirely of) or, alternatively, impregnated or coated with the polymer material 218. In other embodiments, the aperture mask 216 may not be formed of the polymer material 218 and may instead be formed of materials (e.g., metamaterials) that are specifically designed for transmission of the transmitted wave 220a having a wavelength within a defined range suitable for use with a particular type of sensor. In such embodiments, a covering (e.g., a coating, shield, etc.) of the polymer material 218 may be configured to at least partially cover the aperture mask 216 and/or the sensor 206. For example, such a covering of the polymer material 218 may be configured to completely cover (e.g., encapsulate) the aperture mask 216 and the sensor 206, leaving none of either the aperture mask 216 or the sensor 206 exposed. The polymer material 218 may include, without limitation, a material including an elastomer, an acrylic, an epoxy, a resin, a thermoplastic material, or, more specifically, polyetheretherketone (PEEK).

For example, the polymer material 218 may include a wear-resistant material comprising a high-temperature polymer material. As used herein, the term “high-temperature polymer” means and includes, without limitation, polymers formulated to withstand, without substantial degradation over a time period of at least twenty-four hours, temperatures exceeding 200° C. High temperature polymers include, without limitation, high-temperature thermoplastic polymers and high-temperature thermoset plastic polymers. Further, the polymer material 218 may be at least substantially comprised of one or more of a fluoropolymer, a fluoropolymer elastomer, neoprene, buna-N, ethylene diene M-class (EPDM), polyurethane, a thermoplastic polyester elastomer, a thermoplastic vulcanizate (TPV), fluorinated ethylene-propylene (FEP), a fluorocarbon resin, perfluoroalkoxy (PFA), ethylene-chlorotrifluoroethylene copolymer (ECTFE), ethylene-tetrafluoroethylene copolymer (ETFE), nylon, polyethylene, polyvinylidene fluoride (PVDF), polytetrafluoroethylene (PTFE), chlorotrifluoroethylene (CTFE), nitrile, and another fully or partially fluorinated polymer.

As used herein, the term “high-temperature thermoplastic polymer” means and includes, without limitation, PEEK (polyetheretherketone); PEK (polyetherketone); PFA (perfluoroalkoxy); PTFE (polytetrafluoroethylene); FEP (fluorinated ethylene propylene); CTFE (polychlorotrifluoroethylene); PVDF (polyvinylidene fluoride); PA (polyamide); PE (polyethylene); TPU (thermoplastic elastomer); PPS (polyphenylene sulfide); PESU (polyethersulfone); PC (polycarbonate); PPA (polyphthalamide); PEKK (polyetherketoneketone); TPI (thermoplastic polyimide); PAl (polyamide-imide); PI (polyimide); FKM (fluoroelastomer); FFKM (perfluoroelastomer); and FEPM (base resistant fluoroelastomer) and further includes an oligomer, copolymer, block copolymer, ionomer, polymer blend, or combination thereof. Further, the polymer material 218 may include a composition of a high-temperature polymer material and a filler material.

Thus, the polymer material 218 (e.g., a PEEK material) may be provided in order to protect downhole components from being exposed to the high-pressure, high-temperature, and moisture-filled downhole environment. In such conditions, the components may become damaged due to erosion, abrasion, and/or corrosion. In particular, contact of the aperture mask 216 and/or the sensor 206 with fluids (e.g., water, drilling mud, etc.) may alter the capacitance of the piezoelectric ceramic transducer, alter the dielectric constant of the ceramic material, and prevent the sensor from accurately detecting that which it is meant to detect. However, the sensor 206 and the aperture mask 216 that are at least partially covered with the polymer material 218 may be less prone to moisture diffusing therethrough, even under high-pressure, high-temperature conditions in a downhole environment. Therefore, the polymer material 218 may prevent the aperture mask 216 and/or the sensor 206 from coming into contact with the moisture of the downhole environment. As such, the sensor 206 may be more likely to continue to accurately detect signals in the harsh environment compared to sensors that are not covered by a polymer material. As mentioned above, the aperture mask 216 may, alternatively, be formed of or impregnated with a polymer material (e.g., a high-temperature polymer material) suitable for downhole conditions. Accordingly, the disclosed sensor 206, in combination with the aperture mask 216, is configured to detect a signal, such as an acoustic pulse, in an environment at a pressure of between about 30 kpsi and about 50 kpsi and at a temperature of between about 175° C. and about 300° C., and at other pressures and temperatures within such range or the vicinity thereof. Further, the sensor 206 may be configured to detect a signal in an environment below a pressure of 30 kpsi and at a temperature lower than 175° C.

Numerous advantages are achieved by utilizing the downhole imaging systems and downhole assemblies including the imaging device 140 including the sensor 206 (e.g., an acoustic emission transducer) and the aperture mask 216 described above for producing high-resolution 2D or 3D images of the wellbore 100 to determine one or more properties (e.g., identify different geological attributes) of a subterranean formation. By utilizing compressive sensing techniques facilitated by the varying thicknesses of the aperture mask 216, less resources (e.g., transmitters, receivers, processing time, telemetry bandwidth, etc.) may be required by the imaging device 140 and associated components and systems compared to conventional imaging devices. In addition, the individual images 212 produced by the imaging device 140 may be of higher quality (e.g., resolution and composition) compared to downhole images previously produced. Accordingly, the imaging device 140 may be used to produce high-resolution 2D or 3D images of the wellbore 100 and/or the surrounding formation using compressive sensing techniques in order to reduce the burden posed by collecting and processing spatial coordinates (e.g., rotation angle and depth in the wellbore 100) as is required in conventional sensing requirements. The use of compressive sensing allows the use of stitching algorithms to generate the image from individual images 212 without requiring the depth information of the imaging device 140 in the wellbore 100. The individual images 212 may be transmitted to the surface 104 using a communication interface (e.g., telemetry system). At the surface 104, the individual images 212 may be used to generate the image. In alternative embodiments, the image may be generated downhole in the imaging device 140. Furthermore, information obtained from the image may be utilized to alter drilling parameters during downhole operations (e.g., drilling, reaming, logging, etc.) for improved operations. The altering of the drilling parameters may be performed at the surface 104 by either a controller or an operator. In alternative embodiments, the altering of the drilling parameters may be performed downhole by a controller without the interaction of an operator.

Additional nonlimiting example embodiments of the disclosure are set forth below.

Embodiment 1: A downhole imaging system, comprising: an imaging device operably coupled to a drill string and configured to generate an image of a subterranean formation from within a wellbore, the imaging device comprising: a sensor comprising a transmitter and a receiver; and a coding mask located between the sensor and the subterranean formation; and a processor operably coupled to the imaging device.

Embodiment 2: The downhole imaging system of Embodiment 1, wherein the transmitter is a piezoelectric transmitter configured to generate an acoustic signal that passes through the coding mask.

Embodiment 3: The downhole imaging system of Embodiment 1 or Embodiment 2, wherein the transmitter and the receiver of the sensor are the same device.

Embodiment 4: The downhole imaging system of any one of Embodiments 1 through 3, wherein the transmitter is configured to transmit a signal and the receiver is configured to receive a signal, and wherein the sensor is configured to pass each of a transmitted signal and a received signal through the coding mask.

Embodiment 5: The downhole imaging system of any one of Embodiments 1 through 4, wherein the coding mask comprises multiple thicknesses.

Embodiment 6: The downhole imaging system of Embodiment 5, wherein the multiple thicknesses of the coding mask vary randomly.

Embodiment 7: The downhole imaging system of any one of Embodiments 1 through 6, wherein the coding mask comprises or is at least partially covered with a polymer material.

Embodiment 8: The downhole imaging system of any one of Embodiments 1 through 7, wherein the processor is configured to generate the image without using depth information of the imaging device within the wellbore.

Embodiment 9: The downhole imaging system of any one of Embodiments 1 through 8, wherein the processor is configured to generate the image using compressive sensing.

Embodiment 10: The downhole imaging system of any one of Embodiments 1 through 9, wherein the processor generates the image from at least two individual images using a mathematical algorithm, and wherein the at least two individual images at least partially overlap one another.

Embodiment 11: The downhole imaging system of any one of Embodiments 1 through 10, wherein the sensor is configured to receive at least one of an optical signal, a resistivity signal, an x-ray signal, a gamma signal, an electric signal, a magnetic signal, a neutron signal, a nuclear magnetic resonance signal, or a thermal signal.

Embodiment 12: The downhole imaging system of any one of Embodiments 1 through 11, wherein the coding mask is configured to rotate relative to the sensor.

Embodiment 13: A downhole assembly, comprising: at least a portion of a drill string; a sensor coupled to a component of the at least a portion of the drill string, the sensor being located and configured to transmit and receive signals between the sensor and a subterranean formation from within a wellbore; a coding mask comprising a volume of material having a varying thickness, the coding mask configured to provide a compressed measurement of individual data points obtained from the signals transmitted and received with the sensor; and a processor operably coupled to the sensor, the processor configured to compile an image of the subterranean formation based on the compressed measurement of the individual data points.

Embodiment 14: A method of generating an image of a subterranean formation in a wellbore, comprising: conveying a bottom-hole assembly in the wellbore, the bottom-hole assembly comprising an imaging device including a sensor comprising a transmitter and a receiver; moving the sensor in the wellbore; transmitting a wave using the transmitter; receiving a first individual image and a second individual image using the receiver, the second individual image comprising an overlap region with the first individual image; and generating the image using a mathematical algorithm, the first individual image, the second individual image, and the overlap region, wherein transmitting the wave comprises breaking a phase uniformity of the transmitted wave.

Embodiment 15: The method of Embodiment 14, wherein breaking the phase uniformity of the transmitted wave includes locating a coding mask between the sensor and the subterranean formation.

Embodiment 16: The method of Embodiment 14 or Embodiment 15, wherein transmitting the wave comprises transmitting an acoustic wave.

Embodiment 17: The method of any one of Embodiments 14 through 16, wherein generating the image using the mathematical algorithm comprises using a stitching algorithm.

Embodiment 18: The method of any one of Embodiments 14 through 17, wherein receiving the first individual image and the second individual image comprises using compressive sensing.

Embodiment 19: The method of any one of Embodiments 14 through 18, further comprising calibrating the compressive sensing using one of a known image data and a sample.

Embodiment 20: The method of any one of Embodiments 14 through 19, wherein moving the sensor comprises rotating the imaging device in the wellbore.

Embodiment 21: The method of any one of Embodiments 14 through 20, wherein generating the image is performed in the wellbore without using a depth of the imaging device in the wellbore.

Embodiment 22: The method of any one of Embodiments 14 through 21, further comprising altering drilling parameters based on information obtained from the image of the subterranean formation during a drilling or reaming operation.

Although the foregoing description contains many specifics, these are not to be construed as limiting the scope of the disclosure, but merely as providing certain exemplary embodiments. Similarly, other embodiments of the disclosure may be devised that do not depart from the spirit or scope of the disclosure. For example, features described herein with reference to one embodiment also may be provided in others of the embodiments described herein. The scope of the disclosure is, therefore, indicated and limited only by the appended claims and their legal equivalents, rather than by the foregoing description. All additions, deletions, and modifications to the disclosed embodiments, which fall within the meaning and scope of the claims, are encompassed by the disclosure.

What is claimed is:

1. A downhole imaging system, comprising:
an imaging device operably coupled to a drill string and configured to generate an image of a subterranean formation from within a wellbore, the imaging device comprising:
a sensor comprising a transmitter and a receiver; and
a coding mask located between the sensor and the subterranean formation; and
a processor operably coupled to the imaging device.

2. The downhole imaging system of claim 1, wherein the transmitter is a piezoelectric transmitter configured to generate an acoustic signal that passes through the coding mask.

3. The downhole imaging system of claim 1, wherein the transmitter and the receiver of the sensor are the same device.

4. The downhole imaging system of claim 1, wherein the transmitter is configured to transmit a signal and the receiver is configured to receive a signal, and wherein the sensor is configured to pass each of a transmitted signal and a received signal through the coding mask.

5. The downhole imaging system of claim 1, wherein the coding mask comprises multiple thicknesses.

6. The downhole imaging system of claim 5, wherein the multiple thicknesses of the coding mask vary randomly.

7. The downhole imaging system of claim 1, wherein the coding mask comprises or is at least partially covered with a polymer material.

8. The downhole imaging system of claim 1, wherein the processor is configured to generate the image without using depth information of the imaging device within the wellbore.

9. The downhole imaging system of claim 1, wherein the processor is configured to generate the image using compressive sensing.

10. The downhole imaging system of claim 1, wherein the processor generates the image from at least two individual images using a mathematical algorithm, and wherein the at least two individual images at least partially overlap one another.

11. The downhole imaging system of claim 1, wherein the sensor is configured to receive at least one of an optical signal, a resistivity signal, an x-ray signal, a gamma signal, an electric signal, a magnetic signal, a neutron signal, a nuclear magnetic resonance signal, or a thermal signal.

12. The downhole imaging system of claim 1, wherein the coding mask is configured to rotate relative to the sensor.

13. A downhole assembly, comprising:
at least a portion of a drill string;
a sensor coupled to a component of the at least a portion of the drill string, the sensor being located and configured to transmit and receive signals between the sensor and a subterranean formation from within a wellbore;
a coding mask comprising a volume of material having a varying thickness, the coding mask configured to provide a compressed measurement of individual data points obtained from the signals transmitted and received with the sensor; and
a processor operably coupled to the sensor, the processor configured to compile an image of the subterranean formation based on the compressed measurement of the individual data points.

14. A method of generating an image of a subterranean formation in a wellbore, comprising:
conveying a bottom-hole assembly in the wellbore, the bottom-hole assembly comprising an imaging device including a sensor comprising a transmitter and a receiver;
moving the sensor in the wellbore;
transmitting a wave using the transmitter;
receiving a first individual image and a second individual image using the receiver, the second individual image comprising an overlap region with the first individual image; and
generating the image using a mathematical algorithm, the first individual image, the second individual image, and the overlap region,
wherein transmitting the wave comprises breaking a phase uniformity of the transmitted wave.

15. The method of claim 14, wherein breaking the phase uniformity of the transmitted wave includes locating a coding mask between the sensor and the subterranean formation.

16. The method of claim 14, wherein transmitting the wave comprises transmitting an acoustic wave.

17. The method of claim 14, wherein generating the image using the mathematical algorithm comprises using a stitching algorithm.

18. The method of claim 14, wherein receiving the first individual image and the second individual image comprises using compressive sensing.

19. The method of claim 18, further comprising calibrating the compressive sensing using one of a known image data and a sample.

20. The method of claim 14, wherein moving the sensor comprises rotating the imaging device in the wellbore.

21. The method of claim 14, wherein generating the image is performed in the wellbore without using a depth of the imaging device in the wellbore.

22. The method of claim 14, further comprising altering drilling parameters based on information obtained from the image of the subterranean formation during a drilling or reaming operation.
